(19) United States
(12) Patent Application Publication
(10) Pub. No.: US 2026/0101169 A1
(43) Pub. Date: Apr. 9, 2026

(54) METHOD AND APPARATUS FOR SLICE REPLACEMENT IN A COMMUNICATION NETWORK SYSTEM

(71) Applicant: Samsung Electronics Co., Ltd., Suwon-si (KR)

(72) Inventors: Danish Ehsan HASHMI, Bangalore (IN); Anurag MANDILWAR, Bangalore (IN); Arvind RAMAMURTHY, Bangalore (IN); Jagadeesh GANDIKOTA, Bangalore (IN); Lalith KUMAR, Bangalore (IN); Pratibha Kattemane SATYAGANAPATI, Bangalore (IN)

(21) Appl. No.: 19/363,057

(22) Filed: Oct. 20, 2025

Related U.S. Application Data
(63) Continuation of application No. PCT/KR2025/015684, filed on Oct. 1, 2025.

(30) Foreign Application Priority Data
Oct. 3, 2024 (IN) 202441074900
Sep. 12, 2025 (IN) 2024 41074900

(51) Int. Cl. H04W 8/02

(52) U.S. Cl. CPC H04W 8/02

(57) ABSTRACT

The disclosure relates to a fifth generation (5G) or sixth generation (6G) communication system for supporting a higher data transmission rate. A method and system for handling slice replacement in a communication network system are provided. The method includes receiving by the user equipment (UE) Single Network Slice Selection Assistance Information (S-NSSAI) time validity information for Single Network Slice Selection Assistance Information (S-NSSAI) from the first network apparatus. The method includes detecting by the UE that the S-NSSAI time validity information indicates that the S-NSSAI is available. The method includes locally removing by the UE the entry of at least one of a replaced S-NSSAI, an alternative S-NSSAI from an alternative NSSAI, or an S-NSSAI from allowed NSSAI or partially allowed NSSAI when the S-NSSAI time validity information indicates that the S-NSSAI is not available. The entry includes S-NSSAI corresponding to the replaced S-NSSAI or the alternative S-NSSAI.

### CROSS-REFERENCE TO RELATED APPLICATION(S)

This application is a continuation application, claiming priority under 35 U.S.C. § 365 (c), of an International application No. PCT/KR2025/015684, filed on Oct. 1, 2025, which is based on and claims the benefit of an Indian Provisional patent application No. 202441074900, filed on Oct. 3, 2024, in the Indian Intellectual Property Office, and of an Indian Non-Provisional patent application Ser. No. 202441074900, filed on Sep. 12, 2025, in the Indian Intellectual Property Office, the disclosure of each of which is incorporated by reference herein in its entirety.

### FIELD OF INVENTION

The disclosure relates to the field of wireless communication. More particularly, the disclosure relates to methods and systems for managing slice replacement within a communication network system.

### BACKGROUND

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### OBJECT OF INVENTION

Aspects of the disclosure are to address at least the above-mentioned problems and/or disadvantages and to provide at least the advantages described below. Accordingly, an aspect of the disclosure is to handle slice replacement in a communication network system.

Another aspect of the disclosure is to provide an improved method for handling slice replacement in communication network systems that ensures seamless management of Single Network Slice Selection Assistance Information (S-NSSAI) based on time validity information.

Another aspect of the disclosure is to enable a User Equipment (UE) to automatically detect and respond to S-NSSAI availability changes through time validity information, thereby reducing manual intervention and improving network responsiveness.

Another aspect of the disclosure is to implement intelligent de-registration procedures when no allowed S-NSSAI remains available and facilitate dynamic congestion management through alternative slice selection, thereby maintaining service continuity and optimal network resource utilization.

Additional aspects will be set forth in part in the description which follows and, in part, will be apparent from the description, or may be learned by practice of the presented embodiments.

### SUMMARY

In accordance with an aspect of the disclosure, a method for handling slice replacement in a communication network system is provided. The method includes receiving by the UE S-NSSAI time validity information for Single Network Slice Selection Assistance Information (S-NSSAI) from a first network apparatus. Further, the method includes detecting by the UE the S-NSSAI time validity information indicates that the S-NSSAI is available. Further, the method includes locally removing by the UE an entry of at least one of a replaced S-NSSAI, an alternative S-NSSAI from an alternative NSSAI, or a S-NSSAI from allowed NSSAI or partially allowed NSSAI when the S-NSSAI time validity information indicates that the S-NSSAI is not available. The entry includes S-NSSAI corresponding to the replaced S-NSSAI or the alternative S-NSSAI.

In an embodiment, the method includes the entry is deleted by removing a mapping between the replaced S-NSSAI and the alternative S-NSSAI.

In an embodiment, the method includes performing by the UE a de-registration procedure with the first network apparatus, when no S-NSSAI is included in the allowed NSSAI and the partially allowed NSSAI after the removal of the S-NSSAI and a Protocol Data Unit (PDU) session associated with the removed S-NSSAI.

In an embodiment, the method includes sending by the first network apparatus an updated alternative NSSAI to the UE in a downlink Non-Access Stratum (NAS) message. The downlink NAS message includes an entry including a mapping of a replaced S-NSSAI and a newly selected alternative S-NSSAI. The sending of the updated alternative NSSAI occurs during a UE configuration update procedure or during a registration procedure.

In an embodiment, the method includes the updated alternative NSSAI excludes a mapping of replaced Single Network Slice Selection Assistance Information (S-NSSAI) with the alternative S-NSSAI and includes replaced S-NSSAI with an updated alternative S-NSSAI.

In accordance with another aspect of the disclosure, a method for handling slice replacement in a communication network system is provided. The method includes receiving and storing, at a first network apparatus, an allowed Network Slice Selection Assistance Information (NSSAI) and a partially allowed NSSAI from a second network apparatus. Further, the method includes removing by the first network apparatus the Single Network Slice Selection Assistance Information (S-NSSAI) from the allowed NSSAI or the partially allowed NSSAI. The method includes determining, after the removal by the first network apparatus whether the allowed NSSAI and the partially allowed NSSAI include no S-NSSAI. The method includes performing by the first network apparatus a de-registration procedure, when no S-NSSAI is included in the allowed NSSAI and the partially allowed NSSAI after the removal.

In an embodiment, the method includes the de-registration procedure is performed with a cause indicating no allowed S-NSSAI.

In an embodiment, the method includes determining by the first network apparatus that the alternative S-NSSAI associated with the UE is congested. The method includes selecting by the first network apparatus another alternative S-NSSAI to replace the congested alternative S-NSSAI. Further, the method includes updating by the first network apparatus the alternative NSSAI in the UE to include newly selected alternative S-NSSAI. Further, the method includes sending by the network apparatus an updated alternative NSSAI to the UE in a downlink NAS message. The downlink NAS message where the downlink NAS message includes an entry includes a mapping of a replaced S-NSSAI and a newly selected alternative S-NSSAI, and the updated alternative NSSAI excludes the replaced S-NSSAI and the alternative S-NSSAI.

In an embodiment, the method includes the downlink NAS message is a REGISTRATION ACCEPT or UE CONFIGURATION UPDATE COMMAND message.

In an embodiment, the method includes the sending of the updated alternative NSSAI occurs during a UE configuration update procedure or during a registration procedure

In accordance with another aspect of the disclosure, a UE for handling slice replacement in a communication network system is provided. The UE includes a processor, a memory and a slice management controller. The slice management controller is coupled to the memory and the processor. The slice management controller receives the S-NSSAI time validity information for Single Network Slice Selection Assistance Information (S-NSSAI) from the first network apparatus. Further, the slice management controller detects the S-NSSAI time validity information indicates that the S-NSSAI is available. Further, the slice management controller locally removes the entry of at least one of a replaced S-NSSAI, the alternative S-NSSAI from the alternative NSSAI, or the S-NSSAI from allowed NSSAI or partially allowed NSSAI when the S-NSSAI time validity information indicates that the S-NSSAI is not available. The entry includes S-NSSAI corresponding to the replaced S-NSSAI or the alternative S-NSSAI.

In accordance another aspect of the disclosure, a first network apparatus for handling slice replacement in a communication network system is provided. The first network apparatus includes a processor, and memory. The slice management controller is coupled to the memory and the processor. The slice management controller includes receiving the allowed Network Slice Selection Assistance Information (NSSAI) and the partially allowed NSSAI from a second network apparatus. The slice management controller includes removing the Single Network Slice Selection Assistance Information (S-NSSAI) from the allowed NSSAI or the partially allowed NSSAI. The slice management controller includes determining whether the allowed NSSAI and the partially allowed NSSAI include no S-NSSAI after the removal. Further, the slice management controller includes to performing a de-registration procedure when no S-NSSAI is included in the allowed NSSAI and the partially allowed NSSAI after the removal.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF FIGURES

The above and other aspects, features, and advantages of certain embodiments of the disclosure will be more apparent from the following description taken in conjunction with the accompanying drawings, in which:

FIG. 1 is a sequence diagram illustrating the removal of S-NSSAI_1 by the Access and Mobility Management Function (AMF) according to an embodiment of the disclosure;

FIG. 2 is a block diagram that illustrates the UE for handling slice replacement in a communication network system according to an embodiment of the disclosure;

FIG. 3 is a block diagram that illustrates a first network apparatus for handling slice replacement in a communication network system according to an embodiment of the disclosure;

FIG. 4 is a flowchart of a method for handling slice replacement in a communication network system at the UE (101) according to an embodiment of the disclosure;

FIG. 5 is a flowchart of a method for handling slice replacement in a communication network system at the first network apparatus according to an embodiment of the disclosure;

FIG. 6 is a sequence diagram that illustrates the scenario of the AMF triggering the deregistration procedure indicating S-NSSAI which are not allowed according to an embodiment of the disclosure; and

FIG. 7 is a sequence diagram that illustrates the scenario of the AMF triggering any 5G mobility management (MM) NAS Message according to an embodiment of the disclosure.

The same reference numerals are used to represent the same elements throughout the drawings.

### DETAILED DESCRIPTION OF INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings facilitate understanding of various technical features. The embodiments are not limited by these drawings and extend to any alterations, equivalents, and substitutes. Terms like first, second, etc., are used for distinction and do not limit the elements.

In a Fifth Generation Core (5GC) network, the Network Slice Replacement functionality is employed to temporarily substitute a Single Network Slice Selection Assistance Information (S-NSSAI) with an Alternative S-NSSAI when the original S-NSSAI becomes unavailable or experiences congestion. Such replacement ensures continuity of service and efficient utilization of network resources.

In one scenario, when a Network Slice Selection Function (NSSF) detects that an S-NSSAI has become unavailable or congested, for example, based on Operations Administration and Maintenance (OAM) data or Network Data Analytics Function (NWDAF) analytics output, the NSSF may transmit a network slice availability notification corresponding to the S-NSSAI to an Access and Mobility Management Function (AMF). The notification may further include information regarding an Alternative S-NSSAI that can be employed by the AMF to replace the unavailable or congested S-NSSAI, and in case of congestion, the notification may also include congestion mitigation information. Once the S-NSSAI becomes available again, the NSSF notifies the AMF of the availability.

In another scenario, when a Policy Control Function (PCF) determines that an S-NSSAI has become unavailable or congested for a specific User Equipment (UE), for example, based on OAM data or NWDAF analytics output, the PCF may transmit an access and mobility-related policy notification to the AMF. This notification may similarly include information relating to an Alternative S-NSSAI that the AMF may use to replace the unavailable or congested S-NSSAI. Once the S-NSSAI becomes available again for the UE, the PCF notifies the AMF accordingly.

In yet another scenario, the OAM may send a notification to the AMF when an S-NSSAI becomes unavailable or congested and may also provide notification once the S-NSSAI becomes available again. In such cases, the OAM may also provide the Alternative S-NSSAI to the AMF along with congestion mitigation information in situations where the S-NSSAI is congested.

In the context of mobility management, support for network slice replacement by the UE or by the network is optional. When both the UE and the network support network slice replacement and an Access and Mobility Management Function determines that a Single Network Slice Selection Assistance Information (S-NSSAI) included in the allowed Network Slice Selection Assistance Information (NSSAI) requires replacement with an alternative S-NSSAI, the AMF provides the alternative S-NSSAI in the allowed NSSAI if it is not already included, the alternative S-NSSAI in the configured NSSAI if it is not already included, and the alternative S-NSSAI in the Network Slice Aggregation Group (NSAG) information if it is not already included and the UE supports NSAG. Furthermore, the AMF provides the alternative NSSAI including mapping information between the S-NSSAI to be replaced (also referred as replaced S-NSSAI or slice to be replaced) and the corresponding alternative S-NSSAI to the UE during either a generic UE configuration update procedure or a registration procedure.

The AMF provides the alternative NSSAI Information Element (IE) to the UE, which includes mapping of the S-NSSAI (also referred to as S-NSSAI to be replaced) to the Alternative S-NSSAI over the access the AMF wants to trigger Network Slice Replacement. The UE stores the received mapping information together with the received Access Type and only uses it over that access. The alternative NSSAI IE is sent in the downlink NAS (Non-Access Stratum) message (e.g., REGISTRATION ACCEPT or UE CONFIGURATION UPDATE COMMAND).

The AMF may provide the Alternative NSSAI Information Element (IE) in a downlink message such as a REGISTRATION ACCEPT message or a UE CONFIGURATION UPDATE COMMAND message in accordance with Technical Specification (TS) 24.501. The Alternative NSSAI IE contains one or more entries (e.g., entry1, entry2, etc.) where each entry includes a mapping between a slice to be replaced and a corresponding alternative Single Network Slice Selection Assistance Information (S-NSSAI). Both the S-NSSAI to be replaced and the alternative S-NSSAI are required to be present in the allowed NSSAI or the partially allowed NSSAI. The below Table-1A discloses Alternative NSSAI information element.

TABLE 1A
Alternative NSSAI

| | | | | | | | |
|---|---|---|---|---|---|---|---|
| 8 | 7 | 6 | 5 | 4 | 3 | 2 | 1 |

| | |
|---|---|
| Alternative NSSAI IEI | octet 1 |
| Length of Alternative NSSAI contents | octet 2 |
| Entry 1 | octet 3* |
| | octet a* |
| Entry 2 | octet a + 1* |
| | octet b* |
| . . . | octet b + 1* |
| | octet c* |
| Entry n | octet c + 1* |
| | octet d* |

TABLE 1B
Entries

| | | | | | | | |
|---|---|---|---|---|---|---|---|
| 8 | 7 | 6 | 5 | 4 | 3 | 2 | 1 |

| | |
|---|---|
| S-NSSAI to be replaced | octet 3 |
| | octet x |
| Alternative S-NSSAI | octet x + 1 |
| | octet a |

TABLE 2
Alternative NSSAI Information Element

Value part of the Alternative NSSAI information element (octet 3
to d)
The value part of the Alternative NSSAI information element
consists of one or more entries, each entry consists of one S-
NSSAI to be replaced and one alternative S-NSSAI. The number
of entries shall not exceed eight.
S-NSSAI to be replaced (octet 3 to x) (see NOTE)
S-NSSAI to be replaced is coded as the length and value part of S-
NSSAI information element as specified in subclause 9.11.2.8
starting with the second octet.
Alternative S-NSSAI (octet x + 1 to a)
Alternative S-NSSAI is coded as the length and value part of S-
NSSAI information element as specified in subclause 9.11.2.8
starting with the second octet.
NOTE:
The S-NSSAI to be replaced shall be one S-NSSAI included in the allowed NSSAI.

For example, when UE has an allowed set of S-NSSAI including S-NSSAI-1, S-NSSAI-2, and S-NSSAI-3, and the network detects congestion on S-NSSAI-1, the network may replace S-NSSAI-1 with S-NSSAI-3. In such a case, the Access and Mobility Management Function (AMF) updates the UE with the Alternative NSSAI Information Element (IE), where the entry (e.g., entry-1) includes a mapping between S-NSSAI-1 as the S-NSSAI to be replaced and S-NSSAI-3 as the Alternative S-NSSAI.

According to TS 23.501, A network slice may be available for all UEs or a limited number of UEs only for a limited time that is known at the network in advance e.g. by OAM or subscription. The limited time duration may be due to, for example, the fact that network slice is only temporarily or periodically active in the deployment (e.g. for a limited time to serve an event or a UE may be only authorized to access the network slice for a limited time known in advance), or the network slice is being decommissioned at a known future time. This feature is enabled by S-NSSAI validity time that the network and the UE can handle to reduce the signaling load associated to the transitions in registration management (RM) (also referred as Fifth Generation Mobility Management (5GMM)) and Session Management (SM) (or 5GSM) states for the network slice. The UE may indicate its support for temporarily available network slices (indicate S-NSSAI time validity information supported) in the UE MM Core Network Capability (e.g., 5GMM capability IE) in the Registration Request. The AMF, based on OAM configuration or information received from the Unified Data Management (UDM) or NSSF, may indicate to a supporting UE the validity time for one or more S-NSSAIs in the Configured NSSAI in the Registration Accept message or via the UE Configuration Update procedure. In roaming case, the AMF my include the validity time for an S-NSSAI in the Configured NSSAI either because of limited availability of the Visited Public Land Mobile Network (VPLMN)S-NSSAI or the mapped S-NSSAI of the Home Public Land Mobile Network (HPLMN).

According to TS 24.501 mobility management aspect, if the UE has indicated that it supports S-NSSAI time validity information, then the AMF may include the S-NSSAI time validity information for one or more S-NSSAIs included in the configured NSSAI in the REGISTRATION ACCEPT message or the CONFIGURATION UPDATE COMMAND message. When the time validity information of the S-NSSAI indicates that the S-NSSAI is not available and the AMF detects that the S-NSSAI is included in the allowed NSSAI or the partially allowed NSSAI of a User Equipment (UE) which has not indicated support for S-NSSAI time validity information, the AMF shall remove the S-NSSAI from the stored configured NSSAI, the allowed NSSAI, and the partially allowed NSSAI as applicable by transmitting a CONFIGURATION UPDATE COMMAND message.

According to TS.24.501, session management aspects, if the UE supports the supports S-NSSAI time validity information and the S-NSSAI time validity information and the S-NSSAI time validity information indicates that the S-NSSAI is not available, then the UE take below action:
a) initiate UE-requested PDU session release procedure to release any PDU session associated with the S-NSSAI, if the UE is in 5GMM-CONNECTED mode or in 5GMM-CONNECTED mode with RRC inactive indication; or
b) locally release any PDU session associated with the S-NSSAI, if the UE is in 5GMM-IDLE mode.

Further, when the S-NSSAI time validity information in the AMF indicates that the S-NSSAI is not available, independent of whether the UE is in 5GMM-CONNECTED mode, 5GMM-CONNECTED mode with RRC inactive indication or in 5GMM-IDLE mode, the AMF shall request the Session Management Function (SMF) to release any PDU session associated with the S-NSSAI.

The existing systems disclose only that AMF shall remove the S-NSSAI from the stored configured NSSAI (if any), allowed NSSAI (if any), and partially allowed NSSAI (if any) by sending the CONFIGURATION UPDATE COMMAND message. But there is no clarification that in the above scenario, if the S-NSSAI to be removed is the only S-NSSAI in the configured NSSAI, allowed NSSAI, and partially allowed NSSAI, if applicable, and if no other S-NSSAI can be included by the AMF, then what should be the network behavior in this case.

Thus, it is desired to address the above-mentioned disadvantages, issues, or other shortcomings or at least provide a useful alternative.

Existing systems face challenges when a Single Network Slice Selection Assistance Information (S-NSSAI) is temporarily unavailable. The Access and Mobility Management Function (AMF) transmits an alternative Network Slice Selection Assistance Information (NSSAI), including the entry mapping the slice to be replaced to a corresponding alternative S-NSSAI, and may update the Protocol Data Unit (PDU) session. However, these methods do not address scenarios where the User Equipment (UE) needs to move sequentially between multiple alternative S-NSSAIs or when the S-NSSAI to be removed is the only S-NSSAI in the configured allowed or partially allowed NSSAI. Additionally, the behavior of the network and UE in such cases remains undefined, especially when the UE does not indicate support for S-NSSAI time validity information.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

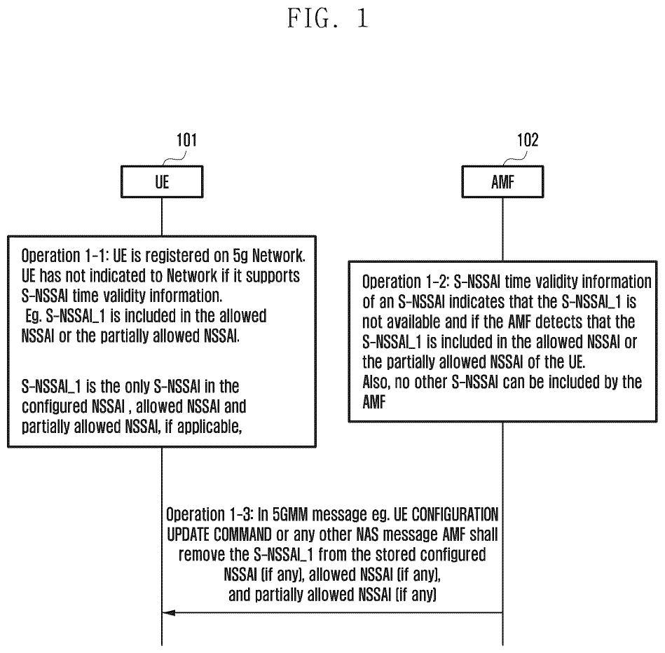

FIG. 1 illustrates a sequence diagram showing the removal of S-NSSAI 1 by the AMF (102) according to an embodiment of the disclosure. Specifically, the AMF (102) removes S-NSSAI_1 from the stored configured NSSAI, the allowed NSSAI, and the partially allowed NSSAI as applicable.

Referring to FIG. 1, at operation 1-1, the UE (101) registers on the 5G network. The UE (101) has not indicated to the network whether it supports the S-NSSAI time validity information. For example, S-NSSAI_1 is included in the allowed NSSAI or the partially allowed NSSAI. S-NSSAI_1 is the only S-NSSAI present in the configured NSSAI, the allowed NSSAI, and the partially allowed NSSAI as applicable.

At operation 1-2, when the S-NSSAI time validity information of the S-NSSAI indicates that S-NSSAI_1 is not available and the AMF (102) detects that S-NSSAI 1 is included in the allowed NSSAI or the partially allowed NSSAI of the UE (101), the AMF (102) further determines that no other S-NSSAI can be included.

At operation 1-3, in a Fifth Generation Mobility Management (5GMM) message such as a UE CONFIGURATION UPDATE COMMAND message or another Non-Access Stratum (NAS) message, the AMF shall remove S-NSSAI 1 from the stored configured NSSAI, the allowed NSSAI, and the partially allowed NSSAI as applicable.

In contrast to the prior art, the embodiments provide methods and systems for sequentially handling multiple alternative S-NSSAIs, including scenarios where the S-NSSAI to be removed is the only S-NSSAI in the allowed, configured, or partially allowed NSSAI. In such embodiments, the UE (101) and the AMF (102) cooperatively update the alternative NSSAI and remove mappings as needed.

Embodiments disclosed herein provide a method and system for handling slice replacement in a communication network. When the UE locally removes either the replaced S-NSSAI or the alternative S-NSSAI from the allowed NSSAI or partially allowed NSSAI based upon S-NSSAI time validity information, the UE (101) shall delete the entry including said replaced S-NSSAI or said alternative S-NSSAI stored in the alternative NSSAI. That is, the mapping between the replaced S-NSSAI and the alternative S-NSSAI is removed.

In an embodiment, when the AMF locally removes either the replaced S-NSSAI or the alternative S-NSSAI from the allowed NSSAI or partially allowed NSSAI based upon S-NSSAI time validity information, the AMF (102) shall delete the entry including said replaced S-NSSAI or the alternative S-NSSAI stored in the alternative NSSAI. That is, the mapping between the replaced S-NSSAI and the alternative S-NSSAI is removed.

In an embodiment, when the UE (101) locally removes either the replaced S-NSSAI or the alternative S-NSSAI from the allowed NSSAI or partially allowed NSSAI based upon S-NSSAI time validity information, the UE (101) shall delete the entry including the replaced S-NSSAI or the alternative S-NSSAI stored in the alternative NSSAI.

In an embodiment, If the UE supporting S-NSSAI time validity information, is configured with S-NSSAI time validity information for an S-NSSAI and the S-NSSAI time validity information indicates that the S-NSSAI is not available, then the UE shall delete the entry from the alternative NSSAI (if any) containing the S-NSSAI in the replaced S-NSSAI or the alternative S-NSSAI stored in the UE

In an embodiment, when the S-NSSAI time validity information of an S-NSSAI indicates that the S-NSSAI is not available and if the AMF detects that the S-NSSAI is included in the allowed NSSAI or the partially allowed NSSAI of a UE which has indicated that it supports S-NSSAI time validity information, then the AMF shall locally remove the S-NSSAI from the allowed NSSAI (if any), and the partially allowed NSSAI (if any) and the entry from the alternative NSSAI (if any) containing the S-NSSAI in the replaced S-NSSAI or the alternative S-NSSAI.

In an embodiment, the following preconditions are established. The first precondition is that the UE (101) has not indicated that it supports the S-NSSAI time validity information to the network. The second precondition is that the UE (101) includes S-NSSAI-1, S-NSSAI-2, S-NSSAI-3, and S-NSSAI-4 in the allowed NSSAI or partially allowed NSSAI and has stored alternative NSSAI with entry-1 including the S-NSSAI-1 as the S-NSSAI to be replaced and the S-NSSAI-3 as the alternative S-NSSAI, and entry-2 including the S-NSSAI-2 as the S-NSSAI to be replaced and the S-NSSAI-4 as the alternative S-NSSAI.

In a first case, when the S-NSSAI time validity information indicates that the S-NSSAI-1 is not available, the network Access and AMF (102) shall transmit a downlink message to the UE (101). This message includes an alternative Network Slice Selection Assistance Information (NSSAI) Information Element (IE) with the entry containing mapping of the S-NSSAI-2 as the S-NSSAI to be replaced and the S-NSSAI-4 as the alternative S-NSSAI. Consequently, the AMF (102) does not include the entry containing the S-NSSAI-1 as the S-NSSAI to be replaced and the S-NSSAI-3 as the alternative S-NSSAI, thereby removing the entry.

In a second case, when the S-NSSAI time validity information indicates that the S-NSSAI-3 is not available, the network AMF (102) may transmit a downlink message to the UE (101). This message includes an alternative NSSAI IE with an entry including mapping of the S-NSSAI-2 as the S-NSSAI to be replaced and the S-NSSAI-4 as the alternative S-NSSAI. Thus, the AMF (102) does not include the entry containing the S-NSSAI-1 as the S-NSSAI to be replaced and the S-NSSAI-3 as the alternative S-NSSAI, thereby removing the entry.

In a third case following case 1 or case 2, when either the S-NSSAI-2 or the S-NSSAI-4 is removed from the allowed NSSAI or partially allowed NSSAI, the AMF (102) shall delete the entry containing the mapping of the S-NSSAI-2 and the S-NSSAI-4. When the deletion of the entry results in no remaining entries in the alternative NSSAI IE, the AMF (102) provides the alternative NSSAI IE with the Length of Alternative NSSAI contents field set to zero during the UE configuration update procedure or registration procedure.

In an embodiment, S-NSSAI can be mapped S-NSSAI or home S-NSSAI, and the UE (101) and AMF (102) shall follow the same procedure.

In an embodiment, when the UE (101) receives the updated NSSAI and the S-NSSAI included in the alternative S-NSSAI is removed from the allowed NSSAI (for example, S-NSSAI-1 is not in the allowed NSSAI), the UE (101) shall delete the entry including the S-NSSAI-1 from the alternative NSSAI (the S-NSSAI-1 is either S-NSSAI to be replaced or alternative S-NSSAI in the alternative NSSAI).

In an additional embodiment, when the UE (101) receives an updated configured NSSAI and the S-NSSAI included in the alternative S-NSSAI is removed from the configured NSSAI (for example, S-NSSAI-1 is no longer in the configured NSSAI), the UE (101) shall delete the entry containing the S-NSSAI-1 from the alternative NSSAI.

The second scenario preconditions are as follows: The first precondition is that the UE (101) has indicated that it supports S-NSSAI time validity information to the network. The second precondition is that the UE (101) has the S-NSSAI-1, S-NSSAI-2, S-NSSAI-3, and S-NSSAI-4 in the allowed NSSAI or partially allowed NSSAI and has stored alternative NSSAI with entry-1 including the S-NSSAI-1 as the S-NSSAI to be replaced and the S-NSSAI-3 as the alternative S-NSSAI, and entry-2 including the S-NSSAI-2 as the S-NSSAI to be replaced and the S-NSSAI-4 as the alternative S-NSSAI.

In case 1, when the S-NSSAI time validity information indicates that the S-NSSAI-1 is not available, the network AMF (102) and the UE (101) remove the entry containing the S-NSSAI-1 as the S-NSSAI to be replaced and the S-NSSAI-3 as the alternative S-NSSAI from the alternative NSSAI.

In case 2, when the S-NSSAI time validity information indicates that the S-NSSAI-3 is not available, the network AMF (102) and the UE (101) remove the entry including the S-NSSAI-1 as the S-NSSAI to be replaced and the S-NSSAI-3 as the alternative S-NSSAI.

In case 3, following case 1 or case 2, when either the S-NSSAI-2 or the S-NSSAI-4 is removed from the allowed NSSAI or partially allowed NSSAI, the AMF (102) and the UE (101) shall delete the alternative NSSAI stored locally in the Mobile Equipment and the AMF.

In an embodiment, cases 1 to 3 apply when the UE (101) has indicated “UE supports network slice usage control” to the network and the S-NSSAI included in the allowed NSSAI or partially allowed NSSAI is removed due to slice deregistration or inactivity timer expiry.

In an embodiment, the S-NSSAI can be a mapped S-NSSAI or a home S-NSSAI, and the UE (101) and AMF (102) shall follow the same procedure.

In an embodiment, when the UE (101) receives the updated allowed NSSAI and the S-NSSAI included in the alternative S-NSSAI is removed from the allowed NSSAI (for example, S-NSSAI-1 is not in the allowed NSSAI), the UE shall delete the entry containing the S-NSSAI-1 from the alternative NSSAI.

In an embodiment, when the UE (101) receives an updated configured NSSAI and the S-NSSAI included in the alternative S-NSSAI is removed from the configured NSSAI (for example, S-NSSAI-1 is no longer in the configured NSSAI), the UE (101) shall delete the entry containing the S-NSSAI-1 from the alternative NSSAI.

In the existing system, when the S-NSSAI is temporarily not available, the AMF (102) transmits the alternative NSSAI including the entry containing mapping of the slice to be replaced and the corresponding alternative S-NSSAI. When a Packet Data Unit (PDU) session is established, the network additionally transmits the PDU session release or PDU session modification and includes the alternative S-NSSAI. However, there are cases where the UE (101) has the PDU session established with S-NSSAI-1 as the slice to be replaced, then the UE (101) moves to alternative S-NSSAI-2 as the alternative S-NSSAI, and then the S-NSSAI-2 becomes congested and the network requires the UE (101) to move to the S-NSSAI-3. This scenario is not currently handled. If this is not handled will cause the service user experience as the PDU session is established with a slice not allowed.

In an embodiment, when the AMF (102) moves the UE (101) from one alternative S-NSSAI to another alternative S-NSSAI, the following procedures are executed: First, the AMF (102) transmits the updated alternative NSSAI to the UE (101) in a downlink Non-Access Stratum (NAS) message including an entry containing mapping of the S-NSSAI-1 as the slice to be replaced and the S-NSSAI-3 as the alternative S-NSSAI, and optionally removing the old entry containing mapping of the S-NSSAI-1 as the S-NSSAI to be replaced and the S-NSSAI-2 as the alternative S-NSSAI. The AMF (102) optionally removes the S-NSSAI-2 from the allowed NSSAI, partially allowed NSSAI, and configured NSSAI. Second, the network, such as the Session Management Function (SMF), includes the alternative S-NSSAI with the S-NSSAI-3 in the PDU session modification request or PDU session release request.

### SUMMARY

In an embodiment, when the alternative NSSAI has an entry containing the mapping of the slice to be replaced as S-NSSAI-1 and the alternative S-NSSAI as S-NSSAI-2, and when the S-NSSAI-2 is an on-demand NSSAI or is included in the S-NSSAI time validity information, the AMF (102) detects that the S-NSSAI-2 is to be removed from the allowed NSSAI or partially allowed NSSAI due to timer conditions such as slice deregistration timer expiry. Additionally, when the S-NSSAI-2 is soon to be not allowed according to the S-NSSAI time validity information, the AMF (102) can move the UE (101) to the slice to be replaced when not congested or move the UE (101) from one alternative S-NSSAI to another alternative S-NSSAI, such as moving the UE (101) from the alternative S-NSSAI-2 to the alternative S-NSSAI-3.

In an embodiment, If the alternative S-NSSAI is not available and the replaced S-NSSAI is not yet available, the AMF provides the updated alternative NSSAI excluding the replaced S-NSSAI and the alternative S-NSSAI to the UE during the UE configuration update procedure or during the registration procedure.

In an embodiment, optimized handling of temporarily available network slices is provided. A network slice may be available for all UEs or only a limited number of UEs for a predefined time interval that is known to the network in advance, for example, by Operations Administration and Maintenance (OAM) configuration or subscription information. The limited time interval may be due to the network slice being temporarily or periodically active in the deployment, such as for serving a scheduled event, or due to the UE (101) being authorized to access the network slice only for a predetermined time, or due to the network slice being decommissioned at a future time. Such handling is facilitated by S-NSSAI time validity information, which can be processed by the UE (101) and the AMF (102) to reduce signaling overhead associated with transitions in Registration Management (RM) and Session Management (SM) states.

In an embodiment, the UE (101) may indicate support for temporarily available network slices in the UE MM Core Network Capability included in the Registration Request. Based on OAM configuration or information received from the Unified Data Management (UDM) or the Network Slice Selection Function (NSSF), the AMF (102) may indicate to the supporting UE (101) the validity time for one or more S-NSSAIs in the Configured NSSAI provided in the Registration Accept message or via the UE Configuration Update procedure. In a roaming scenario, the AMF may include the validity time for an S-NSSAI in the Configured NSSAI either due to the limited availability of the S-NSSAI in the Visited Public Land Mobile Network (VPLMN) or due to the mapped S-NSSAI of the Home Public Land Mobile Network (HPLMN).

In an embodiment, the mobility management procedures are extended to support optimized handling of temporarily available network slices. The support for S-NSSAI time validity information by the UE (101) and the AMF (102) is optional.

In an embodiment, when the UE (101) has indicated support for S-NSSAI time validity information, the AMF (102) may include the S-NSSAI time validity information for one or more S-NSSAIs included in the Configured NSSAI in the Registration Accept message or in a Configuration Update Command message. When the AMF (102) determines that the validity time associated with the S-NSSAI of the Configured NSSAI has changed, the AMF (102) may provide the UE (101) with updated S-NSSAI time validity information for the corresponding S-NSSAI via the Configuration Update Command message.

In the prior art, when the S-NSSAI time validity information associated with an S-NSSAI indicates that the S-NSSAI is not available and when the AMF (102) detects that the S-NSSAI is included in the allowed NSSAI or the partially allowed NSSAI of a UE (101) that has not indicated support for S-NSSAI time validity information, the AMF (102) removes the S-NSSAI from the stored configured NSSAI, allowed NSSAI, and partially allowed NSSAI by transmitting a Configuration Update Command message. However, the existing methods do not address the case where the S-NSSAI to be removed is the only S-NSSAI in the configured NSSAI, allowed NSSAI, or partially allowed NSSAI, and no other S-NSSAI can be included by the AMF. The network behavior in such a situation remains undefined.

In contrast, in an embodiment of the currently existing system, when the UE (101) locally removes either a replaced S-NSSAI or an alternative S-NSSAI from the allowed NSSAI or partially allowed NSSAI based on S-NSSAI time validity information, the UE (101) deletes the corresponding entry stored in the alternative NSSAI. In particular, the mapping between the replaced S-NSSAI and the alternative S-NSSAI is removed upon such deletion.

In yet an embodiment, the scenario considers two S-NSSAIs, namely S-NSSAI-1 and S-NSSAI-2, where the UE (101) has not indicated to the network, for example to the AMF, that it supports S-NSSAI time validity information.

In an embodiment, in a first case, the S-NSSAI-1 and the S-NSSAI-2 are included in the allowed NSSAI or the partially allowed NSSAI and also in the configured NSSAI. When the S-NSSAI time validity information associated with S-NSSAI-1 indicates that S-NSSAI-1 is not available, the network transmits a UE Configuration Update Command (UCU) message to remove S-NSSAI-1 from the configured NSSAI, the allowed NSSAI, and the partially allowed NSSAI.

In an embodiment, in a second case, the S-NSSAI-1 is included in the allowed NSSAI or the partially allowed NSSAI while both the S-NSSAI-1 and the S-NSSAI-2 are included in the configured NSSAI. In the existing system, there is no mechanism for the network to transmit an updated allowed NSSAI containing none of the allowed S-NSSAIs.

In an embodiment, a first solution to the second case (Solution 2A) is that the AMF (102) transmits a UCU message including an updated configured NSSAI that does not include the S-NSSAI-1. In this solution, the AMF (102) also includes the S-NSSAI-1 in the rejected NSSAI or extended rejected NSSAI, for example by rejecting the S-NSSAI-1 for the current Public Land Mobile Network (PLMN) or Standalone Non-Public Network (SNPN). Upon receiving the rejected S-NSSAI, the UE (101) deletes the S-NSSAI-1 from the allowed NSSAI, which results in no remaining allowed NSSAI, and the UE (101) either locally deregisters or initiates a deregistration procedure.

In an embodiment, a second solution to the second case (Solution 2B) is that the AMF (102) transmits a UCU message including an updated configured NSSAI that does not include the S-NSSAI-1. When the UE (101) receives the configured NSSAI without the S-NSSAI-1, the UE (101) deletes the S-NSSAI-1 from the allowed NSSAI or partially allowed NSSAI.

In an embodiment, a third solution to the second case (Solution 2C) is that the AMF (102) transmits a deregistration request and additionally includes the S-NSSAI-1 in the rejected NSSAI or the extended rejected NSSAI or transmits a deregistration request with the 5GMM cause value #62 No network slices available. In this solution, the UE (101) removes the S-NSSAI-1 from the allowed NSSAI upon receiving the rejected NSSAI or extended rejected NSSAI including the S-NSSAI-1 or upon receiving the deregistration request with the 5GMM cause value #62. Optionally, the AMF (102) may also transmit a UCU message including an updated configured NSSAI not containing the S-NSSAI-1. In such a case, when the UE (101) then transmits a Registration Request including the requested NSSAI containing the S-NSSAI-1, the AMF (102) responds with the updated configured NSSAI that excludes the S-NSSAI-1.

In an embodiment, when the S-NSSAI-1 is included in the allowed NSSAI or partially allowed NSSAI and only the S-NSSAI-1 is present in the configured NSSAI, the AMF (102) may send a deregistration request and additionally include the S-NSSAI-1 in the rejected NSSAI or extended rejected NSSAI. Alternatively, the deregistration request may include a 5GMM cause value, for example, cause #62 No network slices available. Upon receiving the rejected NSSAI or extended rejected NSSAI including S-NSSAI-1 or upon receiving the deregistration request with the cause #62, the UE (101) removes the S-NSSAI-1 from the allowed NSSAI, i.e., the AMF (102) include 5GMM cause value to #62 “No network slices available” in deregistration request. In addition, if the UE supports extended rejected NSSAI, the AMF optionally include the Extended rejected NSSAI IE in the DEREGISTRATION REQUEST message; otherwise, the AMF include the Rejected NSSAI IE in the DEREGISTRATION REQUEST message. If the network includes extended rejected NSSAI with S-NSSAI-1 as rejected S-NSSAI then AMF can optionally include the Back-off timer associated with S-NSSAI-1. The AMF may consider the S-NSSAI availability information for the S-NSSAI-1 to determine the back-off timer (for example, the S-NSSAI availability information for the S-NSSAI-1 indicates that S-NSSAI-1 will be available in 30 minutes then AMF may give the backoff timer value of 30 minutes).

In an embodiment the AMF may include optionally one the rejection cause in the rejected S-NSSAI(s):

Further, “S-NSSAI not available in the current PLMN or SNPN”. The UE shall store the rejected S-NSSAI(s) in the rejected NSSAI for the current PLMN or SNPN (as specified in subclause 4.6.2.2) and shall not attempt to use this S-NSSAI in the current PLMN or SNPN over any access until switching off the UE, the UICC containing the USIM is removed, an entry of the “list of subscriber data” with the SNPN identity of the current SNPN is updated, if the UE does not support access to an SNPN using credentials from a credentials holder and equivalent SNPNs, the selected entry of the “list of subscriber data” is updated, if the UE supports access to an SNPN using credentials from a credentials holder, equivalent SNPNs or both or the rejected S-NSSAI(s) are removed (as described in subclause 4.6.2.2).

Further, “S-NSSAI not available in the current registration area”. The UE shall store the rejected S-NSSAI(s) in the rejected NSSAI for the current registration area (as described in subclause 4.6.2.2) and shall not attempt to use this S-NSSAI(s) in the current registration area over the current access until switching off the UE, the UE moving out of the current registration area, the UICC containing the USIM is removed, an entry of the “list of subscriber data” with the SNPN identity of the current SNPN is updated, or the rejected S-NSSAI(s) are removed (as described in subclause 4.6.2.2).

Further, “S-NSSAI not available due to the failed or revoked network slice-specific authentication and authorization”. The UE shall store the rejected S-NSSAI(s) in the rejected NSSAI for the failed or revoked NSSAA (as specified in subclause 4.6.2.2) and shall not attempt to use this S-NSSAI in the current PLMN or SNPN over any access until switching off the UE, the UICC containing the USIM is removed, the entry of the “list of subscriber data” with the SNPN identity of the current SNPN is updated, or the rejected S-NSSAI(s) are removed (as described in subclause 4.6.1 and 4.6.2.2).

“S-NSSAI not available due to maximum number of UEs reached”. Unless the back-off timer value received along with the S-NSSAI is zero, the UE shall add the rejected S-NSSAI(s) in the rejected NSSAI for the maximum number of UEs reached (as specified in subclause 4.6.2.2) and shall not attempt to use this S-NSSAI in the current PLMN or SNPN over the current access until switching off the UE, the universal integrated circuit card (UICC) containing the universal subscriber identity module (USIM) is removed, the entry of the “list of subscriber data” with the SNPN identity of the current SNPN is updated, or the rejected S-NSSAI(s) are removed (as described in subclauses 4.6.1 and 4.6.2.2).

The above-described cases (specifically para 0071-0076) also apply when the UE (101) has not indicated support for UE supports network slice usage control and the S-NSSAI-1 and/or S-NSSAI-2 are on-demand S-NSSAI. In such a case, the AMF (102) may detect that the S-NSSAI-1 or S-NSSAI-2 is not available due to the expiry of the slice deregistration inactivity timer corresponding to the respective S-NSSAI in the allowed NSSAI.

In an embodiment, when the S-NSSAI-1 alone is present in the allowed NSSAI or partially allowed NSSAI and the AMF (102) intends to inform the UE (101) that S-NSSAI-1 is not allowed, the AMF (102) may send a downlink NAS message such as a UE Configuration Update (UCU) or a deregistration request optionally with a re-registration required indication. The AMF (102) may further include the rejected NSSAI or extended rejected NSSAI containing S-NSSAI-1.

In an embodiment, when the S-NSSAI-1 alone is present in the allowed NSSAI or partially allowed NSSAI and the AMF (102) intends to inform the UE (101) that S-NSSAI-1 is not allowed, the AMF (102) may send an updated allowed NSSAI or partially allowed NSSAI excluding S-NSSAI-1 and may set the length of NSSAI contents in the allowed NSSAI or partially allowed NSSAI to zero.

In an embodiment, when S-NSSAI-1 alone is present in the allowed NSSAI or partially allowed NSSAI and the AMF (102) intends to inform the UE (101) that S-NSSAI-1 is not allowed, the AMF (102) may send an updated configured NSSAI excluding S-NSSAI-1. When the UE (101) receives the configured NSSAI without S-NSSAI-1, the UE (101) deletes the S-NSSAI-1 from the allowed NSSAI or partially allowed NSSAI. If no S-NSSAI remains in the allowed NSSAI or partially allowed NSSAI, the UE transitions to the 5GMM-DEREGISTERED state.

In an embodiment, When the S-NSSAI time validity information of an S-NSSAI indicates that the S-NSSAI is not available, the AMF detects that the S-NSSAI is included in the allowed NSSAI or the partially allowed NSSAI of a UE which has not indicated that it supports S-NSSAI time validity information, the AMF (102) shall remove the S-NSSAI from the stored configured NSSAI (if any), allowed NSSAI (if any), and partially allowed NSSAI (if any). If there is no S-NSSAI included in the allowed NSSAI and partially allowed NSSAI after removal of the S-NSSAI from the allowed NSSAI or the partially allowed NSSAI, then the AMF performs the network-initiated de-registration procedure and sets the 5GMM cause value to #62 “No network slices available” in the DEREGISTRATION REQUEST message” and optionally include the S-NSSAI in the rejected NSSAI or extended rejected NSSAI (if UE support extended rejected NSSAI).

In an embodiment, when the slice deregistration inactivity timer associated with S-NSSAI is expired, the AMF (102) detects that the S-NSSAI is included in the allowed NSSAI or the partially allowed NSSAI of the UE (101) which has not indicated that it supports network slice usage control, the AMF shall remove the S-NSSAI from allowed NSSAI (if any), and partially allowed NSSAI (if any). If there is no S-NSSAI included in the allowed NSSAI and partially allowed NSSAI after removal of the S-NSSAI from the allowed NSSAI or the partially allowed NSSAI, then the AMF (102) performs the network-initiated de-registration procedure and sets the 5GMM cause value to #62 “No network slices available” in the DEREGISTRATION REQUEST message” and optionally include the S-NSSAI in the rejected NSSAI or extended rejected NSSAI (if UE support extended rejected NSSAI).

In an embodiment, when S-NSSAI-1 alone is present in the allowed NSSAI or partially allowed NSSAI and the AMF (102) intends to inform the UE (101) that S-NSSAI-1 is not allowed, the AMF (102) may send a deregistration request with re-registration required.

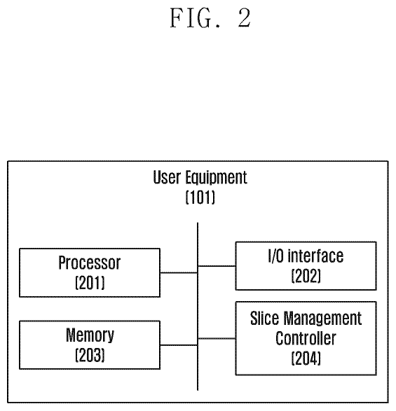

FIG. 2 is the block diagram that illustrates the UE (101) for handling slice replacement in a communication network system according to an embodiment of the disclosure.

Examples of the UE (101) can include but are not limited to Consumer Electronics (such as Mobile Phones and Smartphones), Tablets, Wearable Devices, Television, Computing Devices (such as Laptops, Notebooks, Desktops, Workstations, etc.), Internet of Things (IoT) Devices, Automotive Systems (such as connected cars, Autonomous Vehicles, Vehicle-to-Everything (V2X) communication devices, etc.), Enterprise Devices such as robotics, Specialized Equipment (such as Medical Devices, Public Safety Devices, etc.), Media Devices (such as Gaming Consoles, Streaming Devices, etc.).

Examples of the wireless communication network system include but are not limited to Cellular Networks (such as second generation (2G), third generation (3G), fourth generation (4G), 5G, Beyond 5G (B5G)/6G or advanced cellular networks), Local Area Networks (LANs) (such as Wi-Fi, light fidelity (Li-Fi), etc.), Personal Area Networks (PANs) (such as Bluetooth, Zigbee, Z-Wave, etc.), Wide Area Networks (WANs) (such as Satellite Communication Networks, Long Range Wide Area Network, Narrowband IoT, Low-bandwidth communication for IoT, etc.), Metropolitan Area Networks (MANs), Machine-to-Machine (M2M), Ad Hoc and Mesh Networks, Emerging and Advanced Networks.

Referring to FIG. 2, the UE (101) includes a processor (201), memory (203), an input output (I/O) interface (202), and a Slice Management Controller (204). The UE (101) can be an end-user device that connects with the network apparatus to access services. For example, the UE (101) can include but not be limited to a mobile phone, a smartphone, tablets, laptops, Internet of Things (IoT) devices. Further, the processor (201) of the UE (101) communicates with the memory (203), the I/O interface (202), and the Slice Management Controller (204).

The processor (201) executes instructions stored in the memory (203) to perform various processes. The processor (201) can include one or a plurality of processors, can be a general-purpose processor such as a central processing unit (CPU), an application processor (AP), or the like, a graphics-only processing unit such as a graphics processing unit (GPU), a visual processing unit (VPU), and/or an Artificial Intelligence (AI) dedicated processor such as a neural processing unit (NPU).

Further, the memory (203) of the UE (101) includes storage locations to be addressable through the processor (201). The memory (203) is not limited to a volatile memory and/or a non-volatile memory. Further, the memory (203) can include one or more computer-readable storage media. The memory (203) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (203) can store the media streams such as audio streams, video streams, haptic feedbacks, and the like.

The I/O interface (202) transmits the information between the memory (203) and external peripheral devices. The peripheral devices are the input-output devices associated with the UE (101). The I/O interface (202) receives several pieces of information from the network apparatus.

The slice management controller (204) is coupled to the memory (203) and the processor (201). This coupling allows for efficient data transfer and communication between the components, ensuring that the slice management controller (204) can access and process S-NSSAI time validity information and slice replacement data in real-time. The slice management controller (204) is an innovative integrated circuit that is implemented in the UE (101). In an embodiment, the structure of such an innovative integrated circuit includes a multi-core architecture that enables dynamic management of network slice selection assistance information and slice replacement operations in the communication network system. Each core is optimized for specific tasks such as S-NSSAI time validity detection, slice availability verification, alternative NSSAI mapping processing, allowed NSSAI storage management, and slice removal procedure initiation, etc. The innovative integrated circuit for the management of slice replacement in the communication network system is made of a combination of analog and digital components designed to optimize the power consumption and performance of the slice management mechanism. The analog components include a low-noise amplifier and a high-precision analog-to-digital converter to ensure accurate signal processing of S-NSSAI time validity information. The digital components include a microcontroller unit (MCU) and a digital signal processor (DSP) that work in tandem to dynamically manage the slice replacement configuration updates and alternative NSSAI operations based on network slice availability requirements.

The slice management controller (204) receives the S-NSSAI time validity information for the S-NSSAI from the first network apparatus. Further, the slice management controller (204) detects the S-NSSAI time validity information indicates that the S-NSSAI is available. Further, the slice management controller (204) locally removes the entry of at least one of a replaced S-NSSAI, an alternative S-NSSAI from an alternative NSSAI, or an S-NSSAI from allowed NSSAI or partially allowed NSSAI when the S-NSSAI time validity information indicates that the S-NSSAI is not available. The entry includes the S-NSSAI corresponding to the replaced S-NSSAI or the alternative S-NSSAI.

Further, the slice management controller (204) deletes the entry by removing the mapping between the replaced S-NSSAI and the corresponding alternative S-NSSAI.

The slice management controller (204) causes the UE (101) to perform a de-registration procedure with the first network apparatus (102) (the term ‘first network apparatus’ is interchangeably referred to as ‘AMF’) when no S-NSSAI remains in the allowed NSSAI or the partially allowed NSSAI after removal of the S-NSSAI and a Protocol Data Unit (PDU) session associated with the removed S-NSSAI.

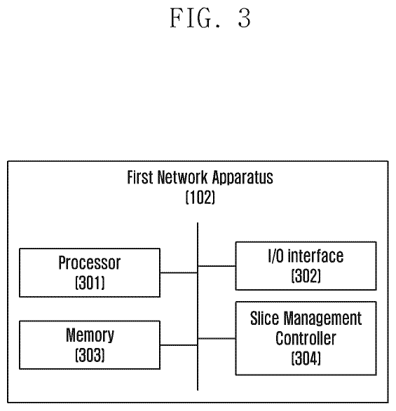

FIG. 3 is a block diagram that illustrates a first network apparatus for handling slice replacement in a communication network system according to an embodiment of the disclosure.

Examples of the first network apparatus (102) (the term ‘first network apparatus’) can include but are not limited to Access and Mobility Management Function (AMF) (102), which is a core network function in 5G networks responsible for registration management, connection management, mobility management, and access authentication. The AMF (102) can be implemented in various network infrastructure configurations such as Cloud-based Network Functions (CNFs) deployed on virtualized infrastructure, Physical Network Functions (PNFs) implemented on dedicated hardware appliances, Edge Computing Platforms for distributed network processing, Multi-access Edge Computing (MEC) nodes for low-latency services, Network Function Virtualization Infrastructure (NFVI) platforms, Software-Defined Networking (SDN) controllers, Private 5G Network Core implementations for enterprise deployments, Public Land Mobile Network (PLMN) core network elements, Standalone (SA) 5G core network functions, Non-Standalone (NSA) 5G network elements integrated with long term evolution (LTE) Evolved Packet Core (EPC), Campus Network Core Functions for educational institutions, Industrial IoT Network Management Systems for manufacturing environments, Mission-Critical Communication Network Core Functions for public safety applications, and Hybrid Cloud-Edge Network Function deployments for optimal performance and coverage.

Referring to FIG. 3, the processor (301) executes instructions stored in the memory (303) to perform various processes. The processor (301) can include one or a plurality of processors, can be a general-purpose processor such as a central processing unit (CPU), an application processor (AP), or the like, a graphics-only processing unit such as a graphics processing unit (GPU), a visual processing unit (VPU), and/or an Artificial Intelligence (AI) dedicated processor such as a neural processing unit (NPU).

Further, the memory (303) of the first network apparatus (102) includes storage locations to be addressable through the processor (301). The memory (303) is not limited to a volatile memory and/or a non-volatile memory. Further, the memory (303) can include one or more computer-readable storage media. The memory (303) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (303) can store the media streams such as audio streams, video streams, haptic feedbacks, and the like.

The I/O interface (302) transmits the information between the memory (303) and external peripheral devices. The peripheral devices are the input-output devices associated with the first network apparatus (102). The I/O interface (302) receives several pieces of information from the network apparatus.

The slice management controller (304) is coupled to the memory (303) and the processor (301). This coupling allows for efficient data transfer and communication between the components, ensuring that the slice management controller (304) can access and process allowed NSSAI, partially allowed NSSAI, and S-NSSAI removal operations in real-time. The slice management controller (304) is an innovative integrated circuit that is implemented in the first network apparatus (AMF) (102). In an embodiment, the structure of such an innovative integrated circuit includes a multi-core architecture that enables dynamic management of network slice selection assistance information and de-registration operations in the communication network system. Each core is optimized for specific tasks such as S-NSSAI time validity monitoring, allowed NSSAI storage management, partially allowed NSSAI processing, alternative S-NSSAI congestion detection, UE (101) capability verification for S-NSSAI time validity support, and de-registration procedure initiation, etc. The innovative integrated circuit for the management of slice replacement in the communication network system is made of a combination of analog and digital components designed to optimize the power consumption and performance of the network slice management mechanism. The analog components include a low-noise amplifier and a high-precision analog-to-digital converter to ensure accurate signal processing of S-NSSAI availability information from the second network apparatus (SMF). The digital components include a microcontroller unit (MCU) and a digital signal processor (DSP) that work in tandem to dynamically manage the slice removal configuration updates, alternative NSSAI mapping operations, and UE (101) configuration update procedures based on network slice availability and congestion requirements.

The slice management controller (304) in the first network apparatus (AMF) (102) receives and stores an allowed Network Slice Selection Assistance Information (NSSAI) and a partially allowed NSSAI from the second network apparatus. The slice management controller (304) in the first network apparatus (102) removes the S-NSSAI from the allowed NSSAI or the partially allowed NSSAI. The slice management controller (304) in the first network apparatus (102) is configured to determine after the removal whether the allowed NSSAI and the partially allowed NSSAI include no S-NSSAI. The slice management controller (304) in the first network apparatus (102) performs a de-registration procedure when no S-NSSAI is included in the allowed NSSAI and the partially allowed NSSAI after the removal.

Further, the slice management controller (304) in the first network apparatus (102) performs the de-registration procedure optionally with a cause indicating no allowed S-NSSAI.

Further, the slice management controller (304) in the first network apparatus (102) performs a de-registration procedure optionally with a cause value indicating no allowed S-NSSAI.

Further, the slice management controller (304) in the first network apparatus (102) determines that the alternative S-NSSAI associated with the UE (101) is congested. Further, the slice management controller (304) in the first network apparatus (102) selects another alternative S-NSSAI to replace the congested alternative S-NSSAI. Further, the slice management controller (304) in the first network apparatus (102) updates the alternative NSSAI in the UE (101) to include newly selected alternative S-NSSAI. Further, the slice management controller (304) in the first network apparatus (102) sends the updated alternative NSSAI to the UE (101) in a downlink NAS message. The downlink NAS message includes an entry including a mapping of a replaced S-NSSAI and newly selected alternative S-NSSAI. The updated alternative NSSAI excludes a replaced S-NSSAI and an alternative S-NSSAI.

Further, the slice management controller (304) in the first network apparatus (102) sends the downlink NAS message. The downlink NAS message is one of a REGISTRATION ACCEPT message or a UE CONFIGURATION UPDATE COMMAND message.

Further, the slice management controller (304) in the first network apparatus (102) sends the updated alternative NSSAI during a UE configuration update procedure or during a registration procedure.

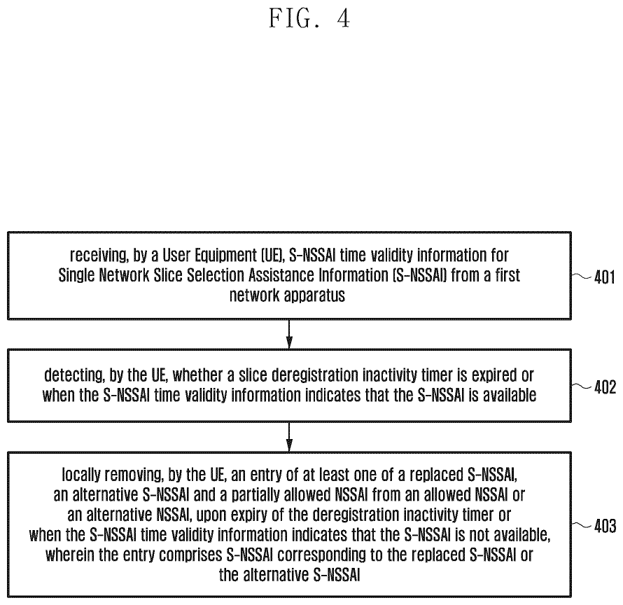

FIG. 4 is a flowchart of a method for handling slice replacement in a communication network system at the UE (101) according to an embodiment of the disclosure.

Referring to FIG. 4, at operation 401, receiving S-NSSAI time validity information for Single Network Slice Selection Assistance Information (S-NSSAI) from the first network apparatus (102) by the UE (101). The S-NSSAI time validity information indicates the availability status of the network slice.

At operation 402, detecting the S-NSSAI time validity information indicates that the S-NSSAI is available by the UE (101). The UE (101) processes the time validity information to determine the current availability status.

At operation 403, locally removing an entry of at least one of a replaced S-NSSAI, an alternative S-NSSAI from an alternative NSSAI, or an S-NSSAI from allowed NSSAI or partially allowed NSSAI when the S-NSSAI time validity information indicates that the S-NSSAI is not available by the UE. The entry includes S-NSSAI corresponding to the replaced S-NSSAI or the alternative S-NSSAI.

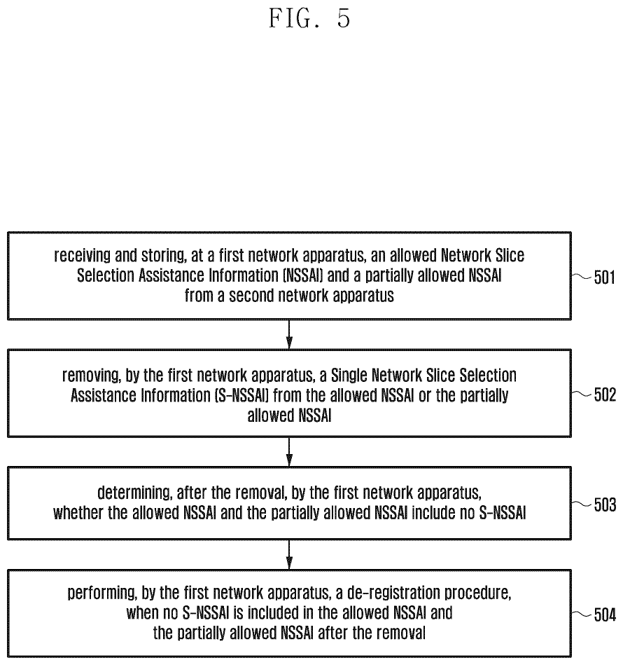

FIG. 5 is a flowchart of a method for handling slice replacement in a communication network system at the first network apparatus according to an embodiment of the disclosure.

Referring to FIG. 5, at operation 501, receiving and storing the allowed NSSAI and the partially allowed NSSAI from the second network apparatus by the first network apparatus (102).

At operation 502, removing the S-NSSAI from the allowed NSSAI or the partially allowed NSSAI by the first network apparatus (102).

At operation 503, determining, after the removal, whether the allowed NSSAI and the partially allowed NSSAI include no S-NSSAI by the first network apparatus (102).

At operation 504, performing a de-registration procedure, when no S-NSSAI is included in the allowed NSSAI and the partially allowed NSSAI after the removal by the first network apparatus (102).

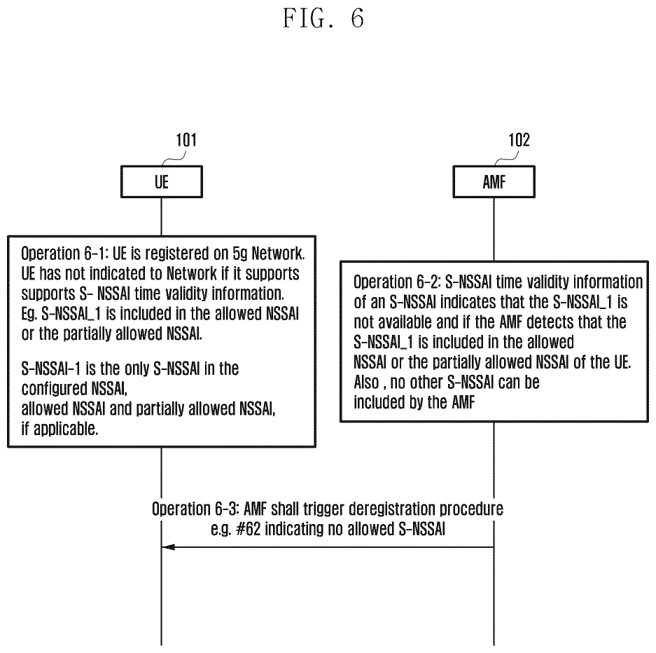

FIG. 6 is a sequence diagram that illustrates the scenario of the AMF (102) triggering the deregistration procedure indicating S-NSSAI which are not allowed according to an embodiment of the disclosure.

In one embodiment, when the time validity information of the S-NSSAI indicates that the S-NSSAI is not available and the AMF (102) detects that the S-NSSAI is included in the allowed NSSAI or the partially allowed NSSAI of the UE (101) which has not indicated support for S-NSSAI time validity information, the following applies: If the S-NSSAI to be removed is the only S-NSSAI present in the allowed NSSAI and the partially allowed NSSAI as applicable, the AMF (102) shall trigger a deregistration procedure optionally including a cause value such as cause #62 indicating no allowed S-NSSAI. Upon receiving the cause code, the UE (101) sets the 5GS update status to 5U2 NOT UPDATED and transitions to the 5GMM-DEREGISTERED-NORMAL-SERVICE state or the 5GMM-DEREGISTERED-PLMN-SEARCH state and further resets the registration attempt counter.

In scenarios where the UE (101) does not support the S-NSSAI time validity information and the AMF (102) removes the S-NSSAI based on the time validity information, if no other S-NSSAI can be included, the AMF (102) triggers the deregistration procedure with, for example, cause #62 indicating no allowed S-NSSAI. Otherwise, the AMF (102) transmits a UE CONFIGURATION UPDATE (UCU) message to the UE removing the S-NSSAI from the allowed NSSAI list. Further, consider two S-NSSAIs, namely S-NSSAI-1 and S-NSSAI-2. The UE (101) has not indicated to the network that it supports S-NSSAI time validity information. When the time validity information of S-NSSAI-1 indicates that S-NSSAI-1 is not available, the network transmits the UE CONFIGURATION UPDATE (UCU) message to remove S-NSSAI-1 from the configured NSSAI list. Optionally, if at least one other S-NSSAI such as S-NSSAI-2 is available in the allowed NSSAI list, the UCU message further includes the updated allowed NSSAI list without S-NSSAI-1. In this case, the AMF (102) removes S-NSSAI-1 from the stored configured NSSAI, the allowed NSSAI, and the partially allowed NSSAI as applicable and transmits a CONFIGURATION UPDATE COMMAND message to the UE (101) to update the corresponding lists.

At operation 6-1, the UE (101) is registered on the 5G network. The UE (101) has not indicated to the network if it supports S-NSSAI time validity information. For example, S-NSSAI_1 is included in the allowed NSSAI or the partially allowed NSSAI, and S-NSSAI_1 is the only S-NSSAI in the configured NSSAI, allowed NSSAI, and partially allowed NSSAI if applicable. At operation 6-2, the S-NSSAI time validity information of the S-NSSAI indicates that the S-NSSAI 1 is not available and the AMF (102) detects that the S-NSSAI 1 is included in the allowed NSSAI or the partially allowed NSSAI of the UE (101). Additionally, no other S-NSSAI can be included by the AMF (102). At operation 6-3, the AMF (102) shall trigger a deregistration procedure, for example, with cause code #62 indicating no allowed S-NSSAI.

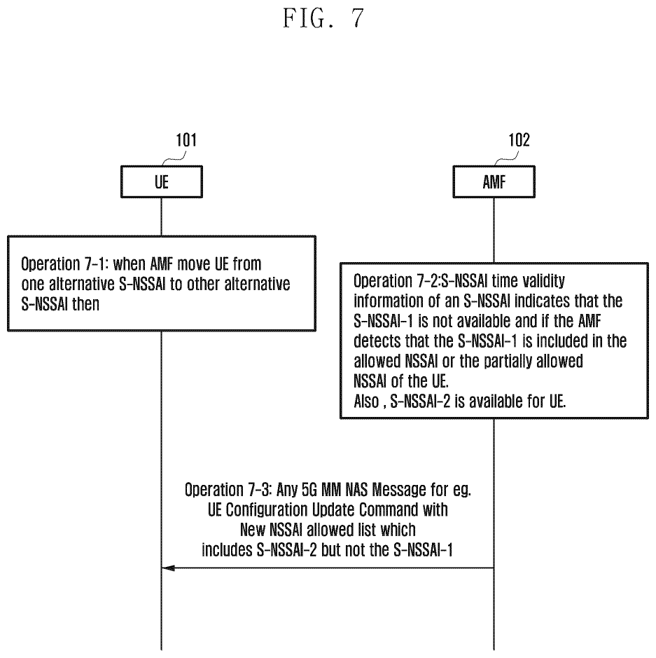

FIG. 7 is a sequence diagram that illustrates the scenario of the AMF (102) triggering any 5G MM NAS Message according to an embodiment of the disclosure.

Referring to FIG. 7, at operation 7-1, the UE (101) maintains registration with the 5G network. The UE (101) has not communicated to the network its capability to support the S-NSSAI time validity information. By way of example, the S-NSSAI_1 is included within the NSSAI or the partially allowed NSSAI of the UE (101). Furthermore, the S-NSSAI_2 is considered for the UE (101). At operation 7-2, the S-NSSAI time validity information corresponding to the S-NSSAI indicates that said S-NSSAI 1 is not available and the AMF (102) detects that S-NSSAI 1 is included within the allowed NSSAI or the partially allowed NSSAI of the UE (101). Additionally, the S-NSSAI 2 remains available for utilization by the UE (101). At operation 7-3, any 5G mobility management (MM) NAS message for, e.g., UE configuration update command with new NSSAI allowed list which includes S-NSSAI_2 but not S-NSSAI 1.

In an embodiment, when the UE (101) locally removes either the replaced S-NSSAI or the alternative S-NSSAI in the allowed NSSAI or partially allowed NSSAI due to S-NSSAI time validity information, the UE (101) shall delete the entry including the replaced S-NSSAI or the alternative S-NSSAI stored in the alternative NSSAI. That is, the mapping between the replaced S-NSSAI and the alternative S-NSSAI is removed. In an embodiment, if the AMF (102) locally removes either the replaced S-NSSAI or the alternative S-NSSAI in the allowed NSSAI/Partially allowed NSSAI due to S-NSSAI time validity information, the AMF (102) shall delete the entry including the replaced S-NSSAI or the alternative S-NSSAI stored in the alternative NSSAI. That is, the mapping between the replaced S-NSSAI and the alternative S-NSSAI is removed. In an embodiment, when the UE (101) locally removes either the replaced S-NSSAI or the alternative S-NSSAI in the allowed NSSAI/Partially allowed NSSAI due to S-NSSAI time validity information, the UE (101) shall delete the entry including the replaced S-NSSAI or the alternative S-NSSAI stored in the alternative NSSAI. If the locally removed on-demand S-NSSAI is included in the entry of the stored alternative NSSAI, the UE (101) shall delete the entry as specified in subclause 4622 of 3GPP TS 23501.

For example, the UE (101) is having S-1 and S-A in the allowed NSSAI list where S-A is the alternative S-NSSAI of S-1, that is, the S-1 and S-A pair indicates an entry of alternative NSSAI. If at least one of the S-1 or S-A is removed from the allowed NSSAI list due to S-NSSAI time validity information, then the UE will delete the information that S-A is an alternative S-NSSAI of S-1. That is, S-1 and S-A are no longer the pairs indicating an entry of alternative NSSAI. In an embodiment, when the S-NSSAI time validity information is configured for S-NSSAIs and the S-NSSAI is an alternative S-NSSAI, then the UE (101) shall remove the entry in the alternative NSSAI including the mapping of alternative S-NSSAI or slice to be replaced locally. When the S-NSSAI time validity information is configured for S-NSSAIs and the S-NSSAI is an alternative S-NSSAI, then the AMF (102) shall remove the entry in the alternative NSSAI including the mapping of alternative S-NSSAI or slice to be replaced locally. This ensures synchronized removal of invalid slice mappings at both UE and network sides.

In an embodiment, when the S-NSSAI time validity information indicates that S-NSSAI=A is not allowed and this is the only S-NSSAI in the allowed NSSAI/configured NSSAI, then the AMF shall send the network-initiated deregistration and include the cause #62 (no network slice available). This mechanism ensures proper handling of scenarios where no valid network slices remain available for the UE, triggering appropriate deregistration procedures with specific cause indication. In an embodiment, if the UE (101) has the alternative S-NSSAI (e.g., S-NSSAI-B) and the alternative S-NSSAI is congested, then the AMF (102) may replace the alternative S-NSSAI (e.g., S-NSSAI-B) with another alternative S-NSSAI (e.g., S-NSSAI-C) by including the updated alternative NSSAI. This dynamic replacement mechanism enables the network to proactively manage congestion by redirecting UE (101) traffic to less congested alternative slices, thereby maintaining service quality and network performance optimization.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE), the method comprising:
receiving, from an access and mobility management function (AMF) entity, a message including an alternative network slice selection assistance information (NSSAI) and single-NSSAI (S-NSSAI) time validity information, wherein the alternative NSSAI comprises an entry including a replaced S-NSSAI and an alternative S-NSSAI to be included in an allowed NSSAI;
removing either the replaced S-NSSAI or the alternative S-NSSAI from the allowed NSSAI, based on the S-NSSAI time validity information; and
deleting the entry from the alternative NSSAI, in case that the replaced S-NSSAI or the alternative S-NSSAI is removed from the allowed NSSAI.

2. The method of claim 1, further comprising:
receiving, from the AMF entity, a de-registration request message comprising a cause value indicating no network slices available, in case that no S-NSSAI is included in the allowed NSSAI after removal of either the replaced S-NSSAI or the alternative S-NSSAI from the allowed NSSAI.

3. The method of claim 1, further comprising:
receiving, from the AMF entity, an updated alternative NSSAI excluding the replaced S-NSSAI and the alternative S-NSSAI.

4. The method of claim 1,
wherein the replaced S-NSSAI or the alternative S-NSSAI is removed from the allowed NSSAI, in case that the S-NSSAI time validity information indicates that S-NSSAI is not available.

5. A method performed by an access and mobility management function (AMF) entity, the method comprising:
transmitting, to a user equipment (UE), a message including an alternative network slice selection assistance information (NSSAI) and S-NSSAI (single-NSSAI) time validity information, wherein the alternative NSSAI comprises an entry including a replaced S-NSSAI and an alternative S-NSSAI to be included in an allowed NSSAI; and
removing either the replaced S-NSSAI or the alternative S-NSSAI from the allowed NSSAI, and the entry from the alternative NSSAI based on the S-NSSAI time validity information.

6. The method of claim 5, further comprising:
transmitting, to the UE, an updated alternative NSSAI excluding the replaced S-NSSAI and the alternative S-NSSAI.

7. The method of claim 5,
wherein the replaced S-NSSAI or the alternative S-NSSAI is removed from the allowed NSSAI, in case that the S-NSSAI time validity information indicates that S-NSSAI is not available.

8. A user equipment (UE) comprising:
at least one transceiver;
at least one processor communicatively coupled to the at least one transceiver; and
memory, communicatively coupled to the at least one processor, storing instructions executable by the at least one processor individually or in any combination to cause the UE to:
receive, from an access and mobility management function (AMF) entity via the at least one transceiver, a message including an alternative network slice selection assistance information (NSSAI) and single-NSSAI (S-NSSAI) time validity information, wherein the alternative NSSAI comprises an entry including a replaced S-NSSAI and an alternative S-NSSAI to be included in an allowed NSSAI,
remove either the replaced S-NSSAI or the alternative S-NSSAI from the allowed NSSAI, based on the S-NSSAI time validity information, and
delete the entry from the alternative NSSAI, in case that the replaced S-NSSAI or the alternative S-NSSAI is removed from the allowed NSSAI.

9. The UE of claim 8, wherein the instructions further cause the UE to:
receive, from the AMF entity via the at least one transceiver, a de-registration request message comprising a cause value indicating no network slices available, in case that no S-NSSAI is included in the allowed NSSAI after removal of either the replaced S-NSSAI or the alternative S-NSSAI from the allowed NSSAI.

10. The UE of claim 8, wherein the instructions further cause the UE to:
receive, from the AMF entity via the at least one transceiver, an updated alternative NSSAI excluding the replaced S-NSSAI and the alternative S-NSSAI.

11. The UE of claim 8,
wherein the replaced S-NSSAI or the alternative S-NSSAI is removed from the allowed NSSAI, in case that the S-NSSAI time validity information indicates that S-NSSAI is not available.

12. An access and mobility management function (AMF) entity, the AMF entity comprising:
at least one transceiver;
at least one processor communicatively coupled to the at least one transceiver; and
memory, communicatively coupled to the at least one processor, storing instructions executable by the at least one processor individually or in any combination to cause the AMF entity to:
transmit, to a user equipment (UE) via the at least one transceiver, a message including an alternative network slice selection assistance information (NSSAI) and single-NSSAI (S-NSSAI) time validity information, wherein the alternative NSSAI comprises an entry including a replaced S-NSSAI and an alternative S-NSSAI to be included in an allowed NSSAI; and
remove either the replaced S-NSSAI or the alternative S-NSSAI from the allowed NSSAI, and the entry from the alternative NSSAI based on the S-NSSAI time validity information.

13. The AMF entity of claim 12, further comprising:
transmit, to the UE via the at least one transceiver, an updated alternative NSSAI excluding the replaced S-NSSAI and the alternative S-NSSAI.

14. The AMF entity of claim 12,
wherein the replaced S-NSSAI or the alternative S-NSSAI is removed from the allowed NSSAI, in case that the S-NSSAI time validity information indicates that S-NSSAI is not available.
